(19) United States
(12) Patent Application Publication
(10) Pub. No.: US 2007/0066344 A1
(43) Pub. Date: Mar. 22, 2007

(54) MOBILE DEVICE WITH DUAL NETWORK CONNECTIVITY

(75) Inventors: LEI PI, Tu-Cheng (TW); TSUNG-FU HUANG, Tu-Cheng (TW); SHU-KEN LIN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/306,461

(22) Filed: Dec. 29, 2005

(30) Foreign Application Priority Data
Sep. 16, 2005 (TW) 94132096

(51) Int. Cl. H04M 1/00

(52) U.S. Cl. 455/550.1

(57) ABSTRACT

A mobile device for communicating in a first network or a second network includes a user interface (10, 10′), a call routing module (20, 20′), a network interface (60, 60′), a first communication module (30, 30′), a second communication module (40, 40′), and a phonebook management module (50, 50′). The call routing module is connected to the user interface for choosing a communication path. The network interface is used for connecting the mobile device to the first network or the second network. The first communication module and the second communication module are respectively connected between the call routing module and the network interface such that the mobile device can be communicated via the first network or the second network. The phonebook management module is also connected between the call routing module and network interface, for storing a communication history of the mobile device.

### DESCRIPTION

1. Field of the Invention

The invention relates to communication devices, and particularly to a mobile communication device.

2. Description of Related Art

In conventional mobile communication systems, the Global System for Mobile Communications (GSM) is the world's most popular wireless phone technology, and mobile devices using GSM are known as GSM mobile devices. In GSM communication systems, users frequently need to pay high calling fees for long-distance calls or roaming services. Furthermore, when a GSM mobile device is in a standby mode, bandwidth is still occupied and electromagnetic waves are radiated, thereby consuming power and reducing the standby time of the GSM mobile device.

The development of Voice over Internet Protocol (VoIP) together with Wi-Fi technology has produced mobile devices supported by VoIP. These devices are known as VoIP mobile devices, and are gradually replacing GSM mobile devices. VoIP mobile devices communicate with each other via conventional Wireless Local Area Networks (WLANs), therefore the calling fees of VoIP mobile devices are lower than those of GSM mobile devices. However, the Wi-Fi networks are generally short-distance networks that only cover limited areas.

Therefore, what is needed is a mobile device that is supported by both GSM and VoIP, so that the mobile device can communicate via different networks as appropriate.

### SUMMARY OF THE INVENTION

An exemplary mobile device for communicating in a first network or a second network comprises a user interface, a call routing module, a network interface, a first communication module, a second communication module, and a phonebook management module. The call routing module is connected to the user interface for choosing a communication path. The network interface is used for connecting the mobile device to the first network or the second network. The first communication module and the second communication module are respectively connected between the call routing module and the network interface such that the mobile device can be communicated via the first network or the second network. The phonebook management module is also connected between the call routing module and network interface, for storing a communication history of the mobile device.

Other advantages and novel features will become more apparent from the following detailed description of preferred embodiments when taken in conjunction with the accompanying drawings, in which: dr

### BRIEF DESCRIPTION OF THE DRAWINGS

FIG. 1 is a block diagram of a mobile device of an exemplary embodiment of the present invention; and

FIG. 2 is a block diagram of a mobile device of another exemplary embodiment of the present invention.

### DETAILED DESCRIPTION

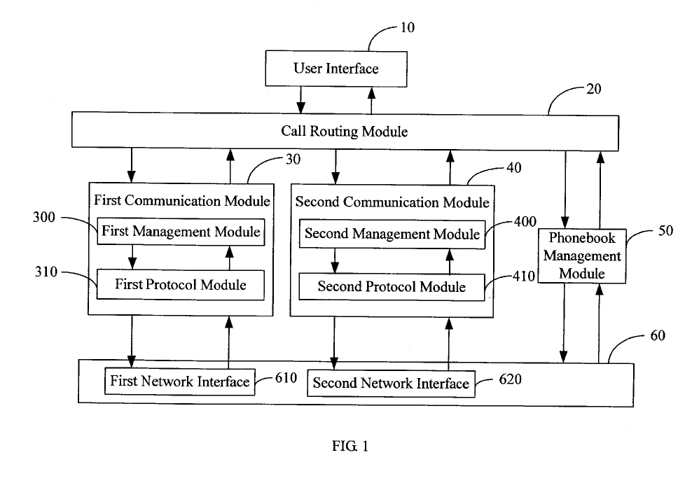

FIG. 1 is a block diagram of a mobile device of an exemplary embodiment of the invention. The mobile device comprises a user interface 10, a call routing module 20, a first communication module 30, a second communication module 40, a phonebook management module 50, and a network interface 60. The first communication module 30 comprises a first management module 300 and a first protocol module 310. The second communication module 40 comprises a second management module 400 and a second protocol module 410. The network interface 60 comprises a first network interface 610 and a second network interface 620. In the exemplary embodiment, the first management module 300 is used for processing communications in a first network, such as a Global System for Mobile communications (GSM) network, and the second management module 400 is used for processing communications in a second network, such as a Voice over Internet Protocol (VOIP) network. In alternative embodiments, the first network can for example be the VoIP network, and the second network can for example be the GSM network.

In the exemplary embodiment, the mobile device is operated in two states: a dialing state, and a receiving incoming call state (hereinafter, ‘receiving state’). The mobile device has a first communication path and a second communication path, respectively corresponding to the first communication module 30 and the second communication module 40.

In the dialing state, the user interface 10 sends phone numbers to the call routing module 20 connected thereto, and the call routing module 20 chooses a communication path according to the phone numbers. That is, the call routing module 20 chooses the first communication path or the second communication path to communicate.

When the first communication path is chosen by the call routing module 20, the first management module 300 sends phone number signals transmitted via the first communication path to the first protocol module 310, and the first protocol module 310 analyzes and transforms the received phone numbers signals to signals recognizable by the first network. Then, the first protocol module 310 sends the transformed phone number signals to the first network through the first network interface 610, such that the first management module 300 connects the mobile device to the first network.

When the second communication path is chosen by the call routing module 20, the second management module 400 sends phone number signals transmitted via the second communication path to the second protocol module 410, and the second protocol module 410 analyzes and transforms the received phone number signals to signals recognizable by the second network. Then, the second protocol module 410 sends the transformed phone number signals to the second network through the second network interface 620, such that the second management module 400 connects the mobile device to the second network.

In the receiving state, the network interface 60 receives an incoming call from the first network or the second network. If the incoming call is received from the first network, the first network interface 610 sends first network incoming call signals to the first communication path. The first protocol module 310 analyzes the first network incoming call signals, and sends the analyzed first network incoming call signals to the user interface 10 via the first management module 300 and the call routing module 20. If the incoming call is received from the second network, the second network interface 620 sends second network incoming call signals to the second communication path. The second protocol module 410 analyzes the second network incoming call signals, and sends the analyzed second network incoming call signals to the user interface 10 via the second management module 400 and the call routing module 20.

In the exemplary embodiment, the phonebook management module 50 is connected between the call routing module 20 and the network interface 60, for storing an ongoing communication history of the mobile device. The communication history may include a received incoming calls history, a missed calls history, and a dialed out calls history.

In the exemplary embodiment, the user interface 10 shows different images when the mobile device is in the dialing state or the receiving state. For example, in the dialing state, the user interface 10 shows a first image; and in the receiving state, the user interface 10 shows a second image.

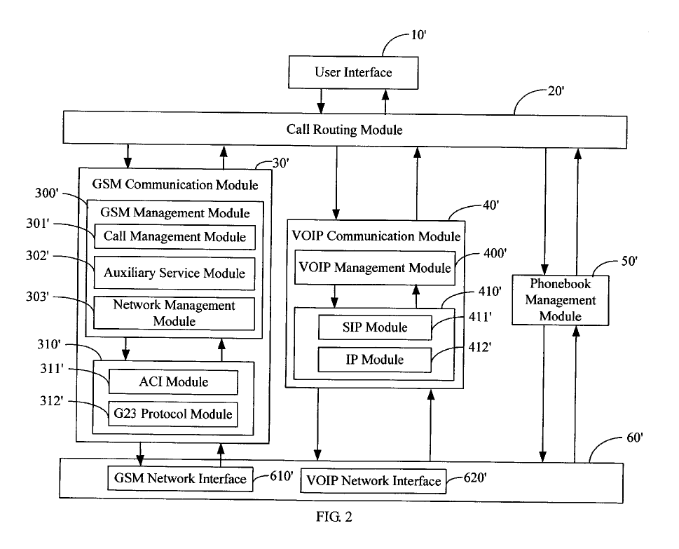

FIG. 2 is a block diagram of a mobile device of another exemplary embodiment of the invention. The mobile device comprises a user interface 10′, a call routing module 20′, a GSM communication module 30′, a VoIP communication module 40′, a phonebook management module 50′, and a network interface 60′.

The GSM communication module 30′ comprises a GSM management module 300′and a GSM protocol module 310′. The VoIP communication module 40′ comprises a VoIP management module 400′ and a VoIP protocol module 410′. The network interface 60′ comprises a GSM network interface 610′ and a VoIP network interface 620′. The GSM management module 300′ comprises a call management module 301′, an auxiliary service module 302′, and a network management module 303′. The GSM protocol module 310′ comprises an AT command interpreting (ACI) module 311′, and a GSM second and third layer (G23) protocol module 312′. The VoIP protocol module 410′ comprises a Session Initiation Protocol (SIP) module 411′ and an Internet Protocol (IP) module 412′.

The mobile device is operated in two states: a dialing state, and a receiving incoming call state (hereinafter, ‘receiving state’). The mobile device has a first communication path and a second communication path, respectively corresponding to the GSM communication module 30′ and the VoIP communication module 40′. In the exemplary embodiment, the first communication path is a GSM communication path, and the second communication path is a VoIP communication path.

In the dialing state, the user interface 10′ sends phone numbers to the call routing module 20′ connected thereto, and the call routing module 20′ chooses a communication path according to the phone numbers. That is, the call routing module 20′ chooses the GSM communication path or the VoIP communication path.

When the GSM path is chosen by the call routing module 20′, the call management module 301′ of the GSM management module 300′ receives phone number signals from the call routing module 20′, and forwards the phone number signals to the ACI module 311′. The ACI module 311′ analyzes the received phone number signals, and sends the analyzed phone number signals to the G23 protocol module 312′. The G23 protocol module 312′ converts the analyzed phone number signals to signals recognizable by the GSM network. Then, the converted signals are sent to the GSM network via the GSM network interface 610′, thereby connecting the mobile device to the GSM network.

In the exemplary embodiment, in addition to a call processing function, the GSM management module 300′ further provides an auxiliary service or a network management function that is used for monitoring a network status. In the exemplary embodiment, the network status comprises an in service status or an out of service status. The auxiliary service provides additional functions such as a call forwarding service and a multi-party call service. If the auxiliary service or the network management function is needed, the user interface 10′ correspondingly sends auxiliary service signals or network management signals to the auxiliary service module 302′ or the network management module 303′. The auxiliary service module 302′ or the network management module 303′ respectively sends the received auxiliary service signals or the received network management signals to the ACI module 311′. The auxiliary service signals or the network management signals are analyzed by the ACI module 311′. Then the G23 protocol module 312′ converts the analyzed signals to signals recognizable by the GSM network.

When the VoIP path is chosen by the call routing module 20′, the VoIP management module 400′ of the VoIP communication module 40′ receives phone number signals from the call routing module 20′, and forwards the phone number signals to the SIP module 411′. The SIP module 411′ analyzes the received phone number signals, transforms the signals to SIP packets, and sends the SIP packets to the IP module 412′. The IP module 412′ converts the received SIP packets to IP packets identifiable by the VoIP network. The IP packets are sent to the VoIP network via the VoIP network interface 620′. In the VoIP path, the VoIP management module 400′ also provides a call processing function, an auxiliary service and a network management function, which are the same as those of the GSM management module 300′ described above.

In the receiving state, the network interface 60′receives an incoming call from the GSM network or the VoIP network. If the incoming call is received from the GSM network, the GSM network interface 610′ sends GSM network incoming call signals to the GSM communication path. The G23 protocol module 311′ analyzes the GSM network incoming call signals, and sends the analyzed GSM network incoming call signals to the user interface 10′via the GSM management module 300′ and the call routing module 20′. If the incoming call is received from the VoIP network, the VoIP network interface 620′sends VoIP network incoming call packets to the VoIP path. The IP module 412′ analyzes and transforms the VoIP network incoming call packets to IP packets, and sends the IP packets to the SIP module 411′. The SIP module 411′ analyzes the IP packets, converts the IP packets to SIP packets, and sends the SIP packets to the user interface 10′via the VoIP management module 400′ and the call routing module 20′.

While embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A mobile device for communicating in a first network or a second network, comprising:
a user interface;
a call routing module connected to the user interface for choosing a communication path;
a network interface for connecting the mobile device to the first network or the second network;
a first communication module connected between the call routing module and the network interface to connect the mobile device to the first network;
a second communication module connected between the call routing module and the network interface to connect the mobile device to the second network; and
a phonebook management module connected between the call routing module and network interface for storing a communication history of the mobile device.

2. The mobile device as claimed in claim 1, wherein the first network is a Global System for Mobile Communications (GSM) network.

3. The mobile device as claimed in claim 1, wherein the second network is a Voice over Internet Protocol (VOIP) network.

4. The mobile device as claimed in claim 1, wherein the first communication module comprises a first management module for processing communications in the first network, the first management module comprising:
a call management module for providing call processing functionality;
an auxiliary service module for providing one or more additional functions other than the call processing functionality; and
a network management module for monitoring a network status.

5. The mobile device as claimed in claim 1, wherein the first communication module is a Global System for Mobile Communications (GSM) module.

6. The mobile device as claimed in claim 1, wherein the first communication module further comprises a first protocol module for changing protocols between the mobile device and the first network.

7. The mobile device as claimed in claim 6, wherein the first protocol module comprises an AT command interpreting (ACI) module for analyzing signals received from the user interface, and a GSM second and third layer (G23) protocol module for receiving analyzed signals and converting the analyzed signals to G23 signals.

8. The mobile device as claimed in claim 7, wherein the ACI module transforms the G23 signals to signals recognizable by the user interface.

9. The mobile device as claimed in claim 1, wherein the second communication module comprises a second management module for processing communications in the second network.

10. The mobile device as claimed in claim 1, wherein the second communication module is a Voice over Internet Protocol (VOIP) communication module.

11. The mobile device as claimed in claim 1, wherein the second management module comprises a second protocol module for changing protocols between the mobile device and the second network.

12. The mobile device as claimed in claim 11, wherein the second management module comprises a Session Initiation Protocol (SIP) module for converting data packets to SIP packets, and an Internet Protocol (IP) module for converting data packets to IP packets.

13. The mobile device as claimed in claim 1, wherein the network interface comprises a first network interface connecting the mobile device to the first network, and a second network interface connecting the mobile device to the second network.

14. The mobile device as claimed in claim 13, wherein the first network interface is a Global System for Mobile Communications (GSM) interface.

15. The mobile device as claimed in claim 13, wherein the second network interface is a Voice over Internet Protocol (VOIP) interface.
